(19) United States
(12) Patent Application Publication
(10) Pub. No.: US 2006/0145399 A1
(43) Pub. Date: Jul. 6, 2006

(54) Method for separating flat ceramic workpieces with a calculated radiation spot length

(76) Inventors: Juergen Weisser, Jena (DE); Stefan Acker, Waldeck (DE); Rony Ullmann, Altenberga (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/563,411

(22) PCT Filed: Jul. 2, 2004
(86) PCT No.: PCT/DE04/01490

§ 371 Date: Jan. 3, 2006

(30) Foreign Application Priority Data
Jul. 2, 2003 (DE) 103 30 179.8

(51) Int. Cl. B29C 37/00; B29C 35/08; H05B 6/00

(52) U.S. Cl. 264/405; 264/430; 264/482; 264/160

(57) ABSTRACT

The invention is directed to a method for splitting a flat ceramic workpiece through provocation of a separation crack due to stresses occurring as a result of temporal and local application of heat by means of laser along a desired splitting line and, following this, a temporal and local removal of heat by means of a coolant, wherein the beam spot length is calculated from the following formula l=8×d×24/WLF, where l is the length of the beam spot, WLF is the thermal conductivity of the ceramic to be split, and d is the thickness of the ceramic to be split, so that the length of the beam spot generated on the workpiece by the laser is selected depending upon the thermal conductivity of the ceramic and upon the thickness of the workpiece. Particularly with workpieces with high internal stress, process parameters such as the laser power or the forward feed speed are changed over the course of the process in order to influence the magnitude of the induced thermal stresses.

### CROSS-REFERENCE TO RELATED APPLICATIONS

This application claims priority of International Application No. PCT/DE2004/001490, filed Jul. 2, 2004 and German Application No. 103 30 179.8, filed Jul. 2, 2003, the complete disclosures of which are hereby incorporated by reference.

### BACKGROUND OF THE INVENTION

a) Field of the Invention

The invention is directed to a method for splitting substantially flat ceramic workpieces through thermally induced stresses by means of laser.

b) Description of the Related Art

For splitting based on thermally induced stresses, a temperature gradient that causes stresses leading to the formation of cracks is generated by temporal and local application of heat to the material and/or removal of heat from the material. Splitting can be carried out by forming a crack that completely penetrates the material or by forming a deep crack and subsequently separating by applying mechanical force.

A great many methods of the type mentioned above are known from the prior art which aim to optimize the results of the process, particularly a high-quality separation edge, through a variety of steps. While the methods described in the patent literature are, as a rule, generally applicable to brittle, nonmetallic materials and therefore to ceramics, the described embodiment examples are limited to glass, which is understandable in view of the following considerations.

The splitting of glass through thermally induced stresses was probably mentioned for the first time in Patent DE 1244346 which was applied for in 1964. A laser beam with a small beam cross section and, therefore, a high energy density was guided (laser line) over the surface of a flat glass provided with a radiation-absorbing layer. As a result of this, through the introduction of heat, the glass is heated along the laser line proceeding from the surface. It was recognized that this has to do not with the absolute value of the heating of the glass but rather with the temperature gradient in the glass transverse to the laser line which can be achieved in particular by cooling subsequent to heating. Even at that time, it was determined that it is not necessary to heat the glass to its melting temperature to achieve the required temperature gradient and that the quality of the split surface resulting from a thermal crack is different than that resulting from the melting of the glass.

Subsequent publications were concerned with optimizing this basic method to increase splitting speed and with improving the accuracy of guiding the splitting line (splitting accuracy) and the surface of the separation edge (edge quality).

As was shown in WO 93/20015 from 1992, the splitting speed in methods of the kind mentioned above was not formerly adequate for the following reasons: By the time the crack begins to form at the edge of a pane of glass, the beam spot is already at a distance from the edge along the laser line. Within this area between the edge of the pane of glass and the beam spot, a complex distribution of thermal stresses forms and initially causes only compressive stresses which do not yet lead to the formation of cracks. With the impingement of coolant, which results in a sudden removal of heat, tension stresses occur which lead to formation of cracks when the tensile strength of the glass is exceeded. As the crack advances, the edges of the material on both sides of the crack are pressed apart so that mechanical stresses occur which promote further propagation of the crack. When the crack approaches the boundary of the pane, the crack curves relative to the laser line, which is explained in connection with this reference by the asymmetry of the thermal stresses in the pane of glass.

The selection of determinate process parameters corresponding to an equation shown in WO 93/20015, according to which a deep crack is formed in a specific direction and with a specific depth, promises improved splitting accuracy and splitting speed. According to this equation, the relative speed is selected depending upon the length and width of an elliptic beam cross section, as is known from SU-A-1231813, a proportionality factor which is determined by the thermophysical and mechanical characteristics of the glass and the beam output density, the interval between the beam spot and the cooling zone, and the desired crack depth determined by the material thickness of the workpiece.

Although it is not mentioned explicitly, the choice of parameters using this formula ultimately serves to achieve the most defined, spatially distributed introduction of thermal stresses.

Later patents are concerned in particular with further development of the geometry of the beam spot which should optimize the input of energy. The embodiment examples are discussed in connection with glass.

For example, WO 96/20062 proposes an energy density distribution which decreases from the periphery to the center (elliptic ring) instead of a Gaussian distribution of the energy density in the beam spot which was formerly conventional. EP 0 872 303 proposes a beam spot shape with an energy density distribution corresponding to a U-shaped or V-shaped curve.

The striving in the prior art to generate homogeneous thermal stresses along the laser line and to influence the quality of the splitting crack by means of specific energy density distributions indicates that it was assumed that amorphous material without internal stresses would be machined, which applies to many types of glass.

When the process is carried out on crystalline material such as ceramic, it must be assumed that the process stresses determining the process run are not defined exclusively by the temporal and spatial formation of induced thermal stresses, but rather that the internal stresses also contribute to the process stresses. The known methods cannot achieve the promised splitting quality, particularly when high internal stresses change along the path of the desired splitting line. The described methods also do not formulate any solutions for the above-mentioned problem of the curvature of the splitting line toward the laser line at the end of the workpiece, which is seen by the present Applicant as a problem of internal stresses.

Apart from the fact that internal stresses are not taken into account in the known methods, which are supposed to be applicable to all nonmetallic, brittle workpieces as a rule, the need for an initial crack is a further indication that these methods are not suitable in practice for ceramics.

For example, it is proposed for the method described in WO 96/20062 to apply a starting cut (initial crack) at the surface of the material along the desired splitting line before the irradiated portion is cooled. While the starting cut was not new in the art and was often implemented in processes for thermal cutting of plates, a new effect resulted in connection with the above-mentioned methods, namely, a very precise cutting control and high-quality edges. The initial crack is also mentioned as a substantial feature in EP 0448168, WO02/48059, and DE 19955824.

The present Applicant knows from practical experience that the presence of an initial crack is not absolutely necessary for splitting glass by means of thermally induced stresses. The fact that an initial crack of this kind is never once mentioned as a necessary precondition in the descriptions of the methods and is also not carried out in every case may be explained in that, in practice, splitting commences from a mechanically cut edge which has, on principle, a large number of microcracks. One of these microcracks serves as an initial crack which propagates as a separation crack. However, when a second splitting cut is made at this laser-cut separation edge and the process parameters are retained, only a heating and subsequent cooling comes about instead of the desired, directed crack formation. This is because this edge has no microcracks that can serve as an initial crack. The need for the initial crack is shown quite clearly in DE 100 41 519 which discloses a method for splitting a flat pane of glass into a plurality of rectangular plates. It is clear from this reference that the person skilled in the art knows that an initial crack is absolutely necessary for splitting panes of glass starting from a separation edge made by thermally induced stresses.

Besides the effort to always achieve a homogeneous introduction of heat along the laser line over the duration of the process and the compulsory placement of an initial crack insofar as the edge at which the cut is started has no microcracks, the present Applicant has recognized another deficiency because of which the known methods cannot readily be applied to the splitting of ceramics in general.

In principle, while taking into account the melting temperature, the material to be split, the given beam spot geometry and the energy density distribution in the beam spot, the introduction of heat is carried out by an optimized combination of the parameters of laser power, beam spot length and forward feed speed, which lead to stresses of sufficient magnitude for the initial crack to propagate.

It is not indicated in the cited prior art that the range of choices for the length of the beam spot is limited by the characteristics of the material to be split or that this choice is optimized by taking these characteristics into account.

Actually, glass can be severed with small or large beam spot lengths (about 2 to 50 mm) depending upon the speed, and the beam spot length need not be adapted for cutting different glasses.

In ceramics, on the other hand, as tests conducted by the present Applicant have shown, the range of beam spot lengths that make it possible to generate the desired crack in the ceramic is not only substantially smaller but also different for different ceramics.

As was already noted, the cited prior art does not show any embodiment example in which the splitting of ceramics is expressly mentioned.

In practice, ceramics are severed by mechanical saws or by means of lasers through so-called scribing, which is also incorrectly referred to as etching. This is not etching in the true sense, but rather ablation of material in the form of blind holes along a line. A laser machining system for implementing a process of this type is known from the brochure from ProCom Systemhaus und Ingenieuruntemehmen GmbH by the designation CNC300.

Very high stresses that can result in the formation of microcracks in the structure are introduced by melting and evaporation of the material.

The method may not be applied to highly tensioned ceramics. An undefined, random breakage occurs. The contamination of the workpiece surface through deposits of the evaporation residues is also a decisive disadvantage.

### OBJECT AND SUMMARY OF THE INVENTION

It is the primary object of the invention to find a method based on splitting material by means of thermally induced stresses which lead to crack formation along a splitting line by which a deep crack of defined depth can be introduced in flat ceramic workpieces at a high process speed in order to reduce the flexural strength of the ceramic in a defined manner along this splitting line so that the workpiece can be split subsequently along the splitting line by applying a defined force.

The object of the invention is met for a method for splitting a flat ceramic workpiece through a method by which such workpieces are subjected to provocation of a separation crack due to stresses occurring as a result of temporal and local application of heat from a laser along a desired splitting line and, following this, a temporal and local removal of heat by means of a coolant, wherein the laser radiation forms a beam spot on the workpiece, the length of the beam spot in the direction of the splitting line being greater than the width of the beam spot perpendicular to the splitting line, and the beam spot length is so adjusted depending upon the thermal conductivity of the workpiece and the material thickness of the workpiece that is as small as necessary for achieving the required temperature gradient for generating the splitting crack in spite of thermal conduction but is also as large as possible in order to achieve the fastest possible introduction of heat and, consequently, a high process speed, wherein the beam spot length is calculated from the following formula:
l=8×d×24/WLF
where 1 is the length of the beam spot, WLF is the thermal conductivity of the ceramic to be split, and d is the thickness of the ceramic workpiece to be split.

Based on the original assumption of the present Applicant that stress-containing ceramics can be severed, in accordance with the task at hand, only when the process parameters are changed over the course of the process while taking into account the internal stress of the workpiece, the present Applicant has sought a way to achieve a sufficiently large process window for the parameters of laser power and forward feed speed that can be changed in a useful manner. In doing so, the present Applicant has come to the realization that the beam spot length, as an essential parameter, must be determined depending upon the thermal conductivity (WLF) and thickness of the workpiece and has found a suitable formula for this purpose. By means of a corresponding choice of beam spot length, a sufficiently large process window is given for adjusting the laser power and forward feed speed (process speed) so that these parameters can be deliberately changed within the process window and fluctuations, e.g., in the laser power or in the impinging beam density due to irregularities in the surface of the workpiece, can be tolerated. It has also been shown that with an appropriate beam spot length, a deliberate change in the process parameters is not absolutely required when the internal stresses in the workpiece are small in relation to the stresses that must be generated in order to form a crack in the workpiece.

During the production of ceramic workpieces, mechanical stresses occur as a matter of course in the various production stages, in aftertreatment or assembly. Particularly in case of inhomogeneous heating or cooling (e.g., cooling after ceramic baking, thermal aftertreatment for surface treatment or for applying coatings) and as a result of shrinkage, stresses are “frozen into” the workpiece and lead to permanent deformations. These stresses may be explained in particular by the different thermal coefficients of expansion of the ceramic granulation (body) and melt phase (impurities) and the different expansion of the structural constitution related to this, as well as by different thermal expansion coefficients between the ceramic (ceramic granulation and impurities) and a coating material. Further, additional internal stresses may have been introduced into the material through high mechanical forces during shaping or mechanical machining of the workpiece such as mechanical cutting of the edges.

The internal stresses cannot be calculated in general, but can be determined empirically within limits.

A first idea of the invention consists in that the internal stresses in the workpiece along the desired splitting line can be determined before the start of the splitting process particularly in workpieces with high internal stress or internal stress which changes drastically along the desired splitting line. This determination is carried out primarily through measuring techniques. The internal stresses can then be derived retroactively after many measurements and by correlating the measurement results with a respective surface curvature of the workpiece along the desired splitting line also by means of a visual comparison of the curvatures of the workpieces.

The measurement of internal stresses should advantageously be carried out on two samples of a workpiece batch. Determination of the second sample serves to confirm the results of the first sample. When the results are identical within the given tolerance limits, it may be assumed that the other workpieces of this batch also have a comparable stress curve along the splitting line. By workpieces of a batch is meant workpieces that were produced and, as the case may be, machined under identical production conditions and machining conditions and which have identical dimensions, particularly the same material thickness. The internal stresses can also be determined empirically by tests.

In order to achieve a deep crack in the ceramic with a constant depth along the entire workpiece, it is important that the induced stresses, in sum with the internal stresses, reaches the range of critical breaking stresses (stresses in which a crack formation occurs). While the internal stresses of the ceramic plate to be split could be determined along the desired splitting line and the permissible breaking stresses must generally be discovered by the manufacturer, the resulting stresses that must be induced cannot be adjusted merely as a function of the path along the laser line.

The induced thermal stresses are a function of a number of process parameters and material parameters, namely:
the laser radiation output
the power density in the beam spot
the shape and surface area of the beam spot
the relative speed between the beam spot and workpiece
the material properties of the workpiece
the thermophysical properties of the coolant
the shape and surface area of the cooling cross section and the distance from the beam cross section.

Therefore, the only remaining possibility is to determine parameter combinations which cause a thermal stress that generates the desired deep crack in sum with the internal stresses through a number of trials.

With given material characteristics of the workpiece, the characteristics of the coolant which are also not changeable within a splitting process, and the beam cross section and coolant cross section which can only be changed with difficulty during the process, this leaves in particular the laser radiation output and the forward feed speed for empirical variation. In order to have sufficient leeway (a process window) for this purpose without heating the material as a result of applying too much energy because of excessive radiation outputs or as a result of insufficient speed leading to the melting of impurities, fixed parameters must be selected for the process in a corresponding manner.

Maximum process windows are achieved when the beam cross section has the greatest possible elongation (beam spot length) in the guiding direction of the beam (forward feed), i.e., the greater the beam spot length, the greater the leeway for varying the forward feed speed and laser radiation output.

Since thermal conduction in the material is carried out equally in all directions, a greater beam spot length assists in increasing the deep application of heat. Whereas almost any beam spot length within the framework of technical possibilities can be selected in glass, the length in ceramics is limited. This is due to the thermal conductivity (WLF) of the materials. While the WLF of glass varies only slightly, e.g., 0.8 W/mK in float glass to 1.2 W/mK in borosilicate glass, the WLF of ceramics can be ten to twenty times or more than 100 times that of glass, e.g., ALN at 180 W/mK. This fact must be taken into consideration in the geometry of the heating zone (beam spot), particularly with regard to its length in direction of the forward feed speed.

The second idea of the invention comes into play in this connection. The maximum useful beam spot length is determined by the thermal conductivity of the material to be severed. The beam spot length must de decreased as thermal conductivity increases so that as little heat as possible is conducted from the splitting line laterally into the adjoining areas. At the same time, however, the beam spot length should be as great as possible so as to have a large process window within which the forward feed speed and the laser power can be varied. In the embodiment examples, beam spot lengths which are optimal for the respective material, that is, which are as large as possible in order to obtain a large process window but also as small as necessary for keeping the lateral heat conduction low, are indicated for materials of different thermal conductivity. Based upon a large number of tests, the present Applicant has developed a formula on the basis of which an optimal beam spot length is determined as a function of the thermal conductivity (WLF) and the material thickness. Adjustment of this beam spot length leads to a large process window within which the laser power and the forward feed speed can be varied sufficiently to change or adjust the induced thermal stresses along the splitting line depending upon internal stresses. Depending upon the internal stresses in the workpiece, suitable parameter combinations can be found for the laser power and the forward feed speed within the process window. These parameters can be varied over the course of the process when the stress ratios vary drastically along the laser line, or they can be adjusted in different ways for workpieces which have different internal stresses, e.g., as a result of varying aftertreatment.

Even when there is no need to change the process parameters because the internal stresses are small and do not vary much over the course of the desired splitting line, the selection of beam spot length based on the formula according to the invention is compulsory for obtaining a separation crack in accordance with the above-stated object. With the process parameters otherwise remaining constant, larger beam spot lengths do not lead to the desired splitting quality or the splitting process does not even take place because the required temperature gradient cannot be achieved through thermal conduction. Shorter beam spot lengths result in a longer process period or in visible interactions (evaporation, melting of the material surface). Accordingly, the highest possible process speeds can be achieved with the beam spot length determined according to the invention. Because of the large process window, variations in laser power do not lead to an impairment of the process. Variations in the energy density also do not affect the beam spot impinging on the workpiece. These variations in energy density result when the relative distance of the focus from the workpiece surface changes along the laser line, e.g., because the workpiece surface is uneven. Tests have shown that a deviation in the calculated beam spot length of up to 10% does not lead to any substantial impairment.

By taking the internal stresses into account on principle in carrying out the process, not only is it possible to split ceramics having internal stresses in a reproducible manner, but also mechanical stresses can be deliberately applied to assist the splitting process. Accordingly, non-oxidic ceramic, for example, in which it is very difficult to induce thermal stresses because of the high thermal conductivity, is prestressed mechanically during the splitting process in such a way that crack formation results even when introducing only small thermal stresses.

By taking the internal stress into account, it is possible to maintain the necessary application of force within a small range of tolerances when splitting ceramics by means of a deep crack and subsequent application of mechanical force. On the one hand, the necessary breaking force should not be too small so as to exclude a premature, unintentional breakage; but it should also not be too high so that the ceramic can be broken along the splitting line in a careful manner with a small expenditure of energy.

Especially thin workpieces are advantageously measured while fixed on the workpiece support which also serves as a support for the subsequent splitting process. In this way, the stresses occurring due to clamping as a result of fixing to the support are also taken into account.

A third idea of the invention relates to crack initiation. The deliberate introduction of an initial crack is superfluous for splitting a ceramic workpiece. As a great number of tests have shown, the crack formation always starts along grain boundaries at which stress maxima occur during production and reheating due to the different expansion coefficients of the ceramic crystals and the melt phase surrounding them or at material transitions which form during ceramic baking due to grain contacts and weak points. The crack then propagates along the grain boundaries in the region of the laser line (the line over which the beam spot passes). While the crack in the amorphous structure of the glass always propagates in a straight line proceeding from an initial crack, the formation and propagation of the crack in the crystalline ceramic, seen microscopically, take place in a wavy manner along the grain boundaries or weak places.

The invention will be described more fully in the following with reference to embodiment examples.

### DESCRIPTION OF THE PREFERRED EMBODIMENTS

In a first embodiment example, a ceramic plate of 96-percent aluminum oxide with a thermal conductivity of 24 W/mK and a thickness of 0.63 mm is split down the middle.

Using the formula according to the invention, l=8×d×24/WLF, where l is the length of the beam spot, WLF is the thermal conductivity of the ceramic to be split, and d is the thickness of the ceramic workpiece to be split, a beam spot length of 5 mm is calculated and a beam spot with the beam spot length of about 5 mm and a beam spot width of about 1 mm is adjusted. At a laser power of 60 watts and a speed of 100 mm/s at which the beam spot is guided over the workpiece, a deep crack not visible to the human eye is generated. By means of a subsequent application of force in the range of 80 to 120 MPa, the workpiece is broken along the splitting line. Additional deep cracks generated in this workpiece or in workpieces of the same material batch with identically selected parameters can be split with the same application of force. A variation of the laser power by 3% and a difference in height of 0.75 mm over the diagonal of the workpiece, which lead to variations in the impinging radiation density along the laser line, lie within the process window and are therefore not problematic. Tests have shown that, with the process parameters otherwise remaining unchanged, the forward feed speed can vary between 50 mm/s and 150 mm/s with this elliptical length of the beam spot and a laser power of 60 W. At a forward feed speed of 100 mm/s, the laser power can be varied between 54 W and 66 W.

In a second embodiment example, a ceramic plate of zirconium oxide with a thermal conductivity of 2.4 W/mK and a thickness of 0.63 mm is split. The selected length of the beam spot is 50 mm, the selected forward feed speed and laser power correspond to the first embodiment example. A variation in this laser power and in the forward feed speed corresponding to the first embodiment example is possible without any noticeable effect on the crack formation.

In a third embodiment example, a ceramic is split according to the first embodiment example. The internal stresses in this ceramic, which has copper structures arranged on it, are too high to be ignored when implementing the process. The internal stresses in this ceramic are appreciably smaller in the edge area that is not coated than in the area of the copper structures. In order to split the ceramic along a line between the structures, with the parameters otherwise remaining the same for the beam spot and the material thickness, either the laser power is fixed and the forward feed speed is varied over the laser line or the forward feed speed is fixed and the laser power varies over the laser line.

Accordingly, e.g., at a laser power of 60 W, the forward feed speed is adjusted starting at 100 mm/s in the free edge area, is then reduced to 70 mm/s in the coated area, and is then increased again the 100 mm/s when leaving the coated area. The two forward feed speeds lie within the process window given for the determined beam spot length for this ceramic material and this workpiece thickness (see the first embodiment example).

Instead of varying the forward feed speed at a constant laser power, the laser power can also be varied at a constant forward feed speed. For example, at a constant forward feed speed of 100 mm/s, the free edge area can first be acted upon starting with a laser power of 60 W, then the structured area can be acted upon on a line between the structures at 66 W and, finally, the free edge area can be acted upon again with a laser power of 60 W to generate the desired separation crack.

While the foregoing description and drawings represent the present invention, it will be obvious to those skilled in the art that various changes may be made therein without departing from the true spirit and scope of the present invention.

1-6. (canceled)

7. A method for splitting flat ceramic workpieces through provocation of a separation crack due to stresses occurring as a result of temporal and local application of heat from a laser along a desired splitting line and, following this, a temporal and local removal of heat by means of a coolant, comprising the steps of:
applying laser radiation to form a beam spot on the workpiece, the length of the beam spot in the direction of a splitting line being greater than the width of the beam spot perpendicular to the splitting line; and
adjusting the beam spot length depending upon the thermal conductivity of the workpiece and the material thickness of the workpiece that it is as small as necessary for achieving the required temperature gradient for generating the splitting crack in spite of thermal conduction but is also as large as possible in order to achieve the fastest possible introduction of heat and, consequently, a high process speed, wherein the beam spot length is calculated from the following formula:
l=8×d×24/WLF,
where l is the length of the beam spot, WLF is the thermal conductivity of the ceramic to be split, and d is the thickness of the ceramic workpiece to be split.

8. The method according to claim 7, wherein no initial crack is generated for initiating the splitting process.

9. The method according to claim 7, wherein the internal stresses of the workpiece along the desired splitting line are determined before the start of the splitting process and the output or the speed is so controlled in a spatially-oriented manner during the splitting process while taking into account the internal stresses that the thermal stresses and the internal stresses along the splitting line, in sum, achieve the breaking stress needed for crack formation.

10. The method according to claim 7, wherein the workpiece is held on a workpiece support accompanied by pretensioning in order to generate additional stresses reinforcing the process stresses.

11. The method according to claim 7, wherein the workpiece is fixed to the workpiece support, on which the workpiece is also held in the same manner during the splitting process, for measuring the internal stress.
